(19) United States
(12) Patent Application Publication
(10) Pub. No.: US 2018/0315393 A1
(43) Pub. Date: Nov. 1, 2018

(54) Display Device and Method for Controlling a Display Device

(71) Applicant: Bayerische Motoren Werke Aktiengesellschaft, Muenchen (DE)

(72) Inventors: Klaus GOFFART, Muenchen (DE); Dominik GUSENBAUER, Seattle, WA (US); Michael KARG, Eching (DE); Christian HUPPERTZ, Muenchen (DE); Olga KARSUNKE, Muenchen (DE); Thomas MANGEL, Muenchen (DE)

(21) Appl. No.: 16/013,125

(22) Filed: Jun. 20, 2018

Related U.S. Application Data
(63) Continuation of application No. PCT/EP2016/081130, filed on Dec. 15, 2016.

(30) Foreign Application Priority Data
Dec. 21, 2015 (DE) 10 2015 226 152.2

(51) Int. Cl. G09G 5/00; B60R 1/12; B60R 16/023

(52) U.S. Cl. CPC G09G 5/003; B60R 1/12; G09G 2380/10; B60R 2001/1215; B60R 2001/1253; B60R 16/023

(57) ABSTRACT

A display device includes an electronically controllable display element for graphical display, a mirror unit which displays an object in mirror image, and a data interface configured to retrieve and/or receive mobility-related data from at least one data source.

### CROSS REFERENCE TO RELATED APPLICATIONS

This application is a continuation of PCT International Application No. PCT/EP2016/081130, filed Dec. 15, 2016, which claims priority under 35 U.S.C. § 119 from German Patent Application No. 10 2015 226 152.2, filed Dec. 21, 2015, the entire disclosures of which are herein expressly incorporated by reference.

This application contains subject matter related to U.S. application Ser. No. ______(Atty Docket No. 080437.PB286US), entitled “Display Device and Operating Device” filed on even date herewith.

### BACKGROUND AND SUMMARY OF THE INVENTION

The invention relates to a display device that includes an electronically controllable display element for graphic displays and a mirror unit. The invention also relates to a method for controlling a corresponding display device.

A display device in which an electronically controllable display element is provided behind a half-mirror is known from US 2005/0018140 A1. The half-mirror is in particular provided to show customers in a hair salon simulations of how a particular hair color changes their appearance. In a first operating mode of the mirror the customers can here observe their original image reflected on the mirror surface as a mirror image. In a second operating mode they can furthermore see the superimposed, electronically generated image with a respective hair color to be simulated, while other body parts of the person, which are recorded live by way of a camera, are also shown under electronic control. In the first operating mode, the electronic display element is conversely deactivated in such a way that no image is displayed. The mirror then acts as a conventional optical mirror. In the second operating mode, the display element is activated, and shines in particular very brightly when the surrounding room is well lit. The superimposition of the electronic image of the person recorded by the camera together with the respective, simulated image of the hair of a different color is controlled by an image processing location processor.

A corresponding mirror with an electronic display system arranged behind a mirror surface of a half-mirror is known from WO 2013/180651 A1, by means of which additional, virtual objects can be electronically added to the mirror image of original objects. For visible light and visible images, the half-mirror is partially transmitting and partially reflecting.

Display devices that exhibit an electronic mirror function, and which can be called electronic mirrors, are also known. A display device of this sort is known, for example, from US 2003/0101105 A1. This device is fitted with a camera which records objects that are located in front of the display device, in particular a person who wants to observe their mirror image. The recorded image of the object is then replayed on a display element of the display device in such a way that the object is virtually reflected in the display element from its observation position, as it is in a natural mirror image. In the particular applications in US 2003/0101 105 A1, clothes fittings are simulated for persons in that electronically provided image data of items of clothing are combined or superimposed in a data processing process with image data of the respective person recorded by the camera, and the image data processed in that manner are then displayed on the display element.

A so-called multimodal traffic application program for planning trips or journeys is known from US 2014/012498 A1, with which a user can optimize his travel time across multiple means of transport, for example between motor vehicles, rail and aircraft.

The content of the above-named publications are hereby expressly incorporated by reference herein.

It is the object of the invention to make information available in an appropriate manner to a user who has a mobility requirement, for his journey.

This and other objects are achieved by a display device according to the invention, comprising: an electronically controllable display element for graphic displays; a mirror unit through which a mirror image of an object is displayed; and a data interface, configured for retrieving and/or receiving mobility-related data from at least one data source.

The mirror unit can be designed as an electronic mirror, and includes in particular a camera, an image processing unit and a display unit. The display unit here can be the above-mentioned display element and/or an additional display element.

The mirror unit can also be designed as a conventional, fully or partially reflecting, optical mirror. The mirror can be partially transparent for light rays that strike a mirror surface of the mirror. The display device can here also include an electronically controllable display element for graphic displays arranged in front of or behind the mirror surface and/or integrated into the mirror surface.

The mirror can be designed as a half-mirror, in particular exhibiting an appropriate reflectivity of at least 50%, in particular 70% to 90%. By means of this kind of half-mirror, display contents of the display element are also visible on the front face of the mirror when the display element is arranged behind the mirror surface or is integrated into it.

A mirror image of an object that is located in a predefined region of the surroundings of the display device is in particular displayed by way of the mirror unit. The object can, in particular, be a person who is using the display device.

With the invention it is possible to make suitable, in particular selected, information available to a user who has a mobility requirement in a manner adapted to his current situation. This is in particular possible in that mobility data are made available through the data source.

Data in particular that relate to an actual or possible mobility requirement, in particular a mobility requirement that can be assigned to a person, can be considered mobility-related data. The mobility requirement can be current or can arise in the future, and in particular can arise within a specific period of time.

The display device, and in particular the mirror, can here in particular be designed as a wall mirror or standing mirror with a suitable size and/or construction, for example with a size from 10 cm to 2 m wide and 10 cm to 2 m high and/or with suitable brackets, supporting feet and/or wall-fastening devices, so that a user can observe himself with a suitable degree of detail or at a suitable size in his mirror image.

The mirror does not necessarily have to be planar and cover a full surface; it can also be designed as an at least partially curved and/or partially mirror-finished object.

The display element can be arranged in a fixed position in front of or behind the mirror surface, and can in particular be firmly attached to it. It can also be joined to it detachably. It can also be embedded in the mirror or in the mirror surface, for example integrated as a laminate.

It is recognized according to the invention that it is particularly advantageous for a person if a mirror of this sort is provided as an item of furniture in a room, for example in the hallway of a dwelling or at a working environment. It is in this case particularly advantageous to provide means with which it is detected whether the person is intending to go to another place, i.e. whether there is a mobility requirement. For this purpose it can in particular be provided that there is an appropriate sensor and/or an appropriate connection to a data source from which the mobility requirement can be derived. The display device can, to this extent, also be thought of as a “springboard to mobility”.

The data source can be or comprise at least one of the following data sources:
a first database, a so-called vehicle database, with data on many vehicles that comprises variable, and in particular current, data on at least one vehicle for private transport; such a data source can, in particular, be a so-called back-end computer which is provided outside a vehicle in a data center and which can be connected with a large number of vehicles via an at least partially radio-controlled communication connection; the vehicles can be passenger automobiles, trucks, motorcycles, buses etc.; the variable data can in particular be current status data of a vehicle, such as the fuel level, charge state of a battery or of a rechargeable battery, the interior temperature of the vehicle etc.;
a second database, a so-called transport database, which comprises in particular mobility-related data for public transport such as rail, suburban train, underground, tram, aircraft, hire car, car sharing offers, taxi stands, etc., wherein the current data can, for example, comprise departure time, arrival time, possible delays, etc.;
a third database, a so-called appointment database, in which appointments for one or a plurality of persons, in particular for the respective user, are stored;
a fourth database, a so-called navigation database, in which navigation data are stored, where this can be assigned in particular to a person and/or assigned to a predefined navigation route;
a fifth database, a so-called profile database, in which data relating to a movement profile of at least one person are stored, e.g. their place of residence, place of work, routes that the person has already taken multiple times, etc.; and/or
a sixth database, a so-called weather database, in which weather data are stored.

By means of the data made available by the respective data sources, the respective mobility requirement of a user can be determined relatively precisely, and recommendations for the respective journey to his destination can advantageously be output for him proactively.

In particular when the display device has already been used by the user, it is possible before he starts out on the actual journey, i.e., for example, while still in the hallway of his dwelling and/or while getting dressed, to determine in this way at an early stage which recommendations are to be output, and for clothing recommendations also to be given to him, for example by means of the display device, or to recommend whether he should advantageously use his private vehicle, such as for example his automobile, or public transport.

By means of the invention it is thus made possible for example for a user to inform himself comprehensively about upcoming appointments and about available means of transport through a last look in the mirror before leaving the dwelling. The respective information can here be displayed on the display device by means of text, numbers, symbols, graphics, tables and/or images.

The display device advantageously comprises a microprocessor and a memory for storing a computer program running on the processor. It is, furthermore, advantageously configured to selectively retrieve data from the data source via the data interface and to control the display device by way of the data that has been called up. In this way the data and/or data derived therefrom can again be selectively displayed on it. In this context, selectively means in particular under program control on the basis of predefined, and in particular selectable, parameters.

According to an advantageous embodiment of the invention, a sensor system is provided comprising at least one sensor, by which an object located in a predefined region around the display device is detectable. The sensor is in particular location-sensitive. It can comprise an optical camera, an ultrasonic or infrared sensor, a radio sensor which for example detects a radio-frequency identification (RFID) element, a near field device (NFD), a mechanical switch and/or another sensor, in particular designed according to an industrial standard. The object can, in particular, be a person, a key, in particular a radio key or a mobile radio device such as, for example, a smartphone. The object can, for example, be a radio key for a vehicle, and in particular comprise a corresponding, electrically active and/or radio-detectable identification element such as, for example, an RFID element.

The display device can, furthermore, be configured, for example by means of a processor and a computer program executable or executed on the processor, to recognize the detected object on the basis of data obtained by the sensor system, for example a specific vehicle key, a specific person, a specific mobile radio device or another specific object. It can be provided here that the display is made dependent on or triggered by the fact that a respective object such as, for example, a key, is located in a predetermined spatial region, for example in or on a predetermined keyholder.

In a further, preferred exemplary embodiment of the invention, the display device is configured to output control data to a private means of transport, e.g. a motor vehicle, and/or to an electric controller. The controller can, in particular, be an integral part of the motor vehicle. The output can be made directly to the vehicle, e.g. via a radio link. It can also be done indirectly by a communication system such as, for example, a back-end server. The output of the control data is, in particular, controlled by way of identification information of the object, for example an ID of an RFID element. By means of the control data it is possible in particular to control vehicle functions such as, for example, switching on the ignition, the engine, and/or the vehicle lights, the air conditioning, the setting of a destination in the navigation device and/or an automatic parking exit function, e.g. for automatically driving the vehicle out of a garage, in particular to a predetermined place in front of the house, so that the user can comfortably get into the vehicle there.

By means of the control data it is also possible to control at least one vehicle-independent controller, in particular a device provided at a premises, for example a garage door drive for opening and closing a garage door, a controller for switching on building lighting, a heating or air conditioning controller of a building, a building alarm installation and/or building blinds. Buildings with equipment that can be controlled in this way are sometimes also known as digitized houses or smart homes. Further communication devices can also be controlled with the control data, for example predetermined application programs (apps) provided on a mobile radio device such as, for example, a messenger app or a tracking app, by which connected devices or their users are informed about the current mobility requirement or activity of the detected object.

A touch-sensitive element, such as are known from, for example, touchscreens, can be provided for operation of the display device, particularly on the mirror surface. A camera system, in particular an optical and/or an infrared camera, can also be provided for operation. The operation of the display device can be performed by use of an operating unit with any desired implementation, for example through virtual buttons which are displayed on the display device by the display element. The corresponding operating unit can comprise a controller which can, for example, also recognize gestures of the user such as, for example, predetermined hand-movement gestures.

A range of advantages can be achieved with the invention, for example a better or easier control by the user of his own vehicle, a faster overview of the vehicle status or, for example, the charge state of the vehicle battery, whereby in particular the usability of a partially or wholly electrically driven vehicle can be improved. Furthermore, no further device such as, for example, a smartphone on which a vehicle-specific application program is installed is necessary for the user to obtain information about the vehicle. It is in addition possible for the user to obtain a quick overview of a plurality of transport means that are available. In addition, a coordination of the present locations, destinations and/or destination times is also possible for a plurality of persons.

In further exemplary embodiments of a display device which, in particular, can be combined with the remaining equipment and methods described in this document, but otherwise can also be designed in each case independently of these, a mirror and an electronically controllable display element (display) are provided. The user of the display device can here see himself at least partially in the mirror, and additional information can be shown to him by way of the display element. The additional information comprises, for example, an input element which is in particular operable by gestures. The input element can, for example, be a turn and push switch as is sometimes provided nowadays in vehicles, and is known, in BMW vehicles for example, under the name “iDrive controller”. The input element can be shown on the display element in particular in such a way that it is superimposed for the user in his mirror image, for example at one of his hands, as a virtual, graphic input element. The gestures of the respective hand of the user are, furthermore, captured by a suitable sensor system (e.g. an optical camera) and used to control a system. When a system of this type is provided inside and/or outside a vehicle, it is for example possible for functions that until now could be operated by a user with an electromechanical turn/push switch inside the vehicle to be operated by the displayed virtual turn/push switch from inside and/or outside the vehicle, while the user only has to execute similar, in particular the same, hand gestures as with the mechanical operation.

It can further be provided that a fictional line is superimposed on the display element of an appropriate display device, which from the point of view of the user extends from the mirror image of one of his body parts that are provided for the operation of a control system, for example from the mirror image of an operating hand or of an operating finger, to a selection surface displayed on the display element. Pointing or operating gestures can be made virtually visible with this feature, and an easily recognized feedback given to the user of what effect his gesture is having at the virtual operating surface, for example on which virtual operating button it is acting.

In further exemplary embodiments of a display device that comprises at least one mirror and one electronically controllable display element, at least one item of information is displayed on the display element in such a way that, from the point of view of the user of the display device standing in front of it, it is not superimposed on his mirror image. The respective information can be an item of information mentioned in this document and, in particular, an item of mobility information described here.

The display device can, in particular, comprise a sensor that captures the position of an object that is located in a predetermined region of the surroundings of the display device. On the basis of the captured position, the display can be controlled by information, in particular of the mirror image of the object and/or additional information which in particular is made available and/or called up from a data source. With this, an adaptation in particular of the pictorial illustration of the electronically displayed additional information on the operator silhouette visible in the mirror image is permitted in such a way that there is no superimposition of the respective images, in particular not one that is disturbing for the user.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a display device.

FIG. 2 shows an information and control system comprising a display device.

### DETAILED DESCRIPTION OF THE DRAWINGS

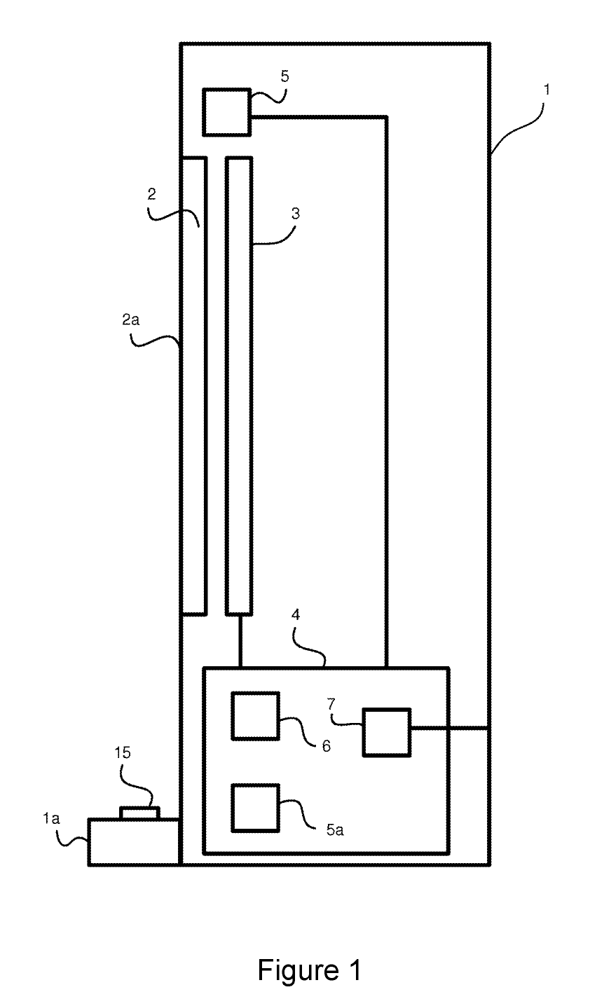

The display device 1 illustrated in FIG. 1 in the form of a wall mirror comprises a planar mirror 2 at its left front face which is semi-transparent for light rays that strike the mirror surface 2a from the left, for example with a reflectivity of 70%.

The display device 1 additionally comprises an electronically controllable display element 3 in the form of an LED display lying behind the mirror 2 or on the surface of the mirror 2 (right) that lies opposite to the mirror surface 2a. An electronic controller 4 comprising a microprocessor 6 on which a computer program runs is provided for control of the display element 3. A sensor 5 in the form of an optical camera is furthermore provided, with which objects, in particular objects and/or persons that are located to the left of (in front of) the mirror 2, can be recognized. The respective recognition can take place in the camera 5 itself and/or by means of the control device 6 and, in particular, by way of the computer program running therein. The display device 1 can be connected via a data interface 7 to external data sources and, in particular, via a fully or partially wired and/or wireless network connection to the Internet and/or can exchange data with a vehicle controller and/or with controllers for equipment provided at buildings such as for example a heating installation or an electric garage door drive 14.

By means of an RFID reading device 5a of the controller 4, the display device 1 can, for example, recognize whether a radio key 15 for a vehicle has been placed immediately in front of it on a keyholder la of the display device 1 and/or has been moved away from it. If the radio key 15 is simply put down, data relating to the vehicle status such as for example the fuel level, battery charge state, interior temperature, etc. is displayed. If the radio key 15 is moved away from the keyholder 1a, this is recognized in the controller 4 as a sign that a person who moves the radio key 15 has a mobility requirement. The controller 4 therefore determines on the basis of further camera signals whether a person is located in front of the display device 1, and examines whether data is present for the person in order to identify them and, if relevant, to make profile data of the person available or to call it up. The controller 4 retrieves data from at least one data source via the interface 7, and controls the display element 3 in such a way that mobility-related data or information is displayed in the form of text, numbers, graphics, etc.. At the same time, virtual operating elements can be displayed, with which the display and/or further actions can be controlled by the detected person (the user) of the display device.

If the radio key 15 is moved away from the keyholder 1a, the controller 4 determines the identity of the radio key 15 by way of the RFID reading device 5a, and thereby also the vehicle belonging to it, and furthermore determines via the interface 7 the parking position at which the associated vehicle is located. This can be done through a direct or indirect data connection to a control device of the vehicle, wherein in particular GPS coordinates of the current whereabouts of the vehicle are transmitted. The status of a plurality of vehicles that are assigned to the radio key 15, the display device, the detected person and/or at least one further person can also be displayed.

A connection of the controller 4 to the Internet in particular can take place, and thus be established to a large number of data sources in order to call up data, in particular mobility-relevant data, via the interface 7. For example here it is possible, through the transmission of suitable, secured access data, for appointment information for the recognized person to also be called up from a personal calendar of the person and displayed on the display element 3. According to the appointment information, in particular relating to the place, time, occasion/topic and/or appointment partner and, if relevant, information made available via the interface 7 relating to various means of transport and/or vehicles, it is possible for a recommendation as to which means of transport or with which multiple intermodal means of transport the person best reaches the appointment to be calculated in the controller 4 and output. The calculation can be controlled variably by use of parameters such as, for example, “as early as possible”, “as punctually as possible” or “with the fewest possible means of transport”. If, through the evaluation of at least one cost parameter, e.g. the calendar and/or current whereabouts of multiple appointment partners by means of predetermined parameters, it is found that, for example, it is more efficient in terms of travel time and/or energy consumption for the partners to meet at a different location and/or at a different time, then a corresponding recommendation for rescheduling the appointment can be output to at least one of the persons or to at least one of the communication systems and/or display devices etc. used by them.

In another application it is possible to recognize by way of the controller 4 of the display device 1 that a particular means of transport, for example the only motor vehicle of a family, should be used by one of the family members at a particular point in time, for example by the mother at 7:30 AM in order to drive the children to school. If it is recognized by the display device 1 shortly before this point in time that another person moves the relevant vehicle key, for example the father on the way to an appointment, a warning can be output that the vehicle is required by the mother, and a recommendation for an alternative means of transport output automatically to the father. The father can, for example, through the use of a corresponding public database for car sharing vehicles, be advised by the display element 3 that a free car sharing vehicle is located in the immediate neighborhood of the residence. The father may then be able to reserve the car sharing vehicle immediately through the display device 1 and the Internet connection. The display device can also comprise acoustic input and/or output devices (microphone, loudspeaker).

The position of the mobility-related information displayed in each case on the display element 3 can in particular be controlled such that from the point of view of the person it is not superimposed on their mirror image displayed in the mirror 2. The appropriate control is achieved here on the basis of the position (in particular the distance and angle) of the eyes of the person relative to the mirror surface determined with the camera 5, and takes the fundamental law of optical reflection into account. Parallax effects can also be considered here.

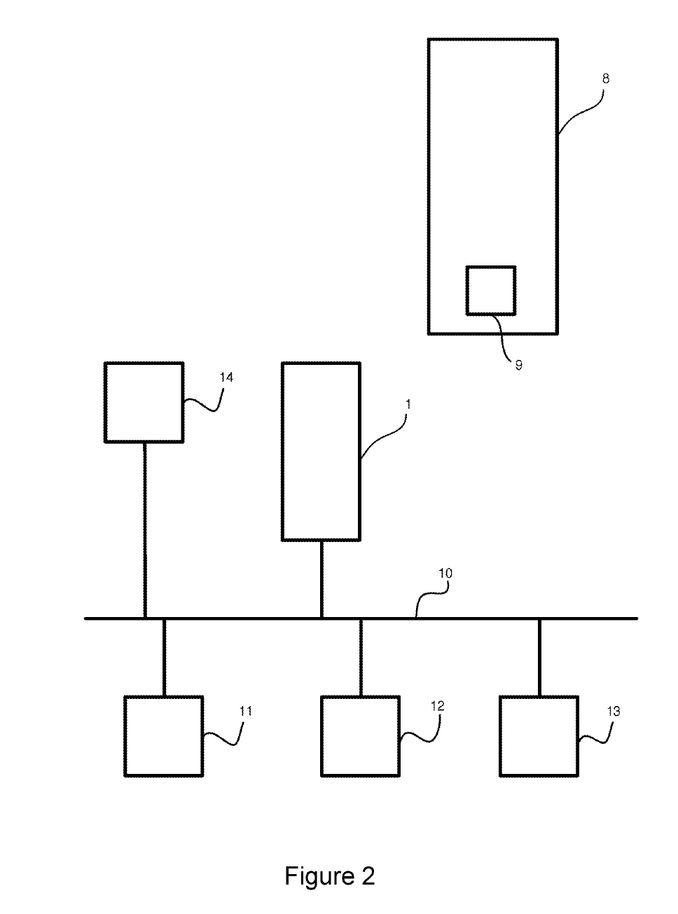

The display device 1 of FIG. 1 is shown in FIG. 2 with its connection to the Internet 10 and to various databases. A database 11 contains data for public transport, which contains connections to local and long-distance transport by use of trains, buses, ferries etc., as well as on flight connections. A database 12 contains personally specific appointments, and a database 13 of a so-called back-end server contains data on a large number of vehicles, including a vehicle 8. Data can be transmitted from the vehicle 8 via a radio interface to corresponding remote terminals, for example via a mobile radio connection using at least one of the mobile radio standards GSM, 3G, 4G, 5G, or according to another radio-based communication standard such as a wireless local area network (WLAN) or Bluetooth. The display device 1 can have a corresponding radio connection in its interface 7. A device 14 such as, for example, a garage door drive that is provided in a premises can also be controlled directly or indirectly by way of the display device 1 over the Internet 10. The premises can include one or more buildings and/or outbuildings. The display device 1 can, in particular, itself be provided, in particular fastened, in one of these buildings.

The devices and system components described are, in particular, controlled with computer programs and can for this purpose comprise further elements, known per se, of computers and digital control equipment such as a microprocessor, volatile and non-volatile memory, interfaces, etc.. The invention can therefore also be realized fully or partially in the form of a computer program product which, when loaded into and executed on a computer, wholly or partially effects a procedure according to the invention. It can, for example, be made available in the form of a data carrier such as a CD/DVD, or also in the form of one or a plurality of files on a server, from which the computer program can be downloaded.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A display device, comprising:
an electronically controllable display element for graphic displays;
a mirror unit through which a mirror image of an object is displayed; and
a data interface, configured for retrieving and/or receiving mobility-related data from one or more data sources.

2. The display device as claimed in claim 1, wherein
the mirror unit comprises a mirror that is partially transparent for light rays that strike a mirror surface of the mirror, and
the display element is arranged in front of or behind the mirror surface and/or is integrated into the mirror surface.

3. The display device as claimed in claim 2, wherein the one or more data sources comprise one or more of:
a first vehicle database, that contains variable data relating to at least one vehicle for private transport,
a second transport database, which contains data relating to public transport,
a third appointment database, in which appointments for one or a plurality of persons are stored,
a fourth navigation database, in which navigation data are stored,
a fifth profile database, in which data relating to a movement profile of at least one person are stored, and
a sixth weather database, in which weather data are stored.

4. The display device as claimed in claim 1, further comprising:
a microprocessor and a non-transitory memory for storing a computer program running on the microprocessor, wherein
the processor is configured to selectively retrieve data from the data source via the data interface and to control the display element by the data that has been retrieved.

5. The display device as claimed in claim 1, further comprising:
a sensor system comprising at least one sensor, by which an object located in a predefined region of the surroundings of the display device is detectable.

6. The display device as claimed in claim 5, wherein
the display device is configured to recognize the object detected on the basis of data obtained by the sensor system.

7. The display device as claimed in claim 1, further comprising:
an operating interface which is configured for a control by gesture.

8. The display device as claimed in claim 1, wherein
the display device is configured to output control data to a private means of transport and/or an electric controller.

9. The display device as claimed in claim 1, wherein
the display device is configured to output control data to a vehicle-independent device.

10. A method for controlling a display device that comprises an electronically controllable display element for graphic displays, as well as a mirror unit through which a mirror image of an object is displayed, and a data interface, the method comprising the acts of:
retrieving and/or receiving mobility-related data, via the display device, from at least one data source; and
outputting a display, via the mirror unit display element, based on the mobility-related data.

11. The method as claimed in claim 10, wherein
on the basis of the mobility-related data received, a vehicle and/or a vehicle-independent device is controlled.
